(19) United States
(12) Patent Application Publication
(10) Pub. No.: US 2014/0068481 A1
(43) Pub. Date: Mar. 6, 2014

(54) Rich User Experience in Purchasing and Assignment

(71) Applicant: Clint H. O'Connor, Austin, TX (US)

(72) Inventor: Clint H. O'Connor, Austin, TX (US)

(21) Appl. No.: 13/596,505

(22) Filed: Aug. 28, 2012

(51) Int. Cl. G06F 3/048

(52) U.S. Cl. 715/769

(57) ABSTRACT

A system, method, and computer-readable medium are disclosed for assisting a user in performing a drag-and-drop operation within a graphical user interface (GUI). Drag-and-drop assistance operations are initiated by the selection of a source graphical object within a GUI. Association data corresponding to the selected source graphical object is processed to identify associated target graphical objects. Once the associated target graphical objects have been identified, visual indication data is processed to generate a visual cue, which is then displayed within the GUI and used to assist the user in performing a drag-and-drop operation.

### BACKGROUND OF THE INVENTION

1. Field of the Invention

The present invention relates to the management of information handling systems. More specifically, embodiments of the invention provide a system, method, and computer-readable medium for assisting a user in performing a drag-and-drop operation within a graphical user interface (GUI).

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Over the years, many advances have been made in the design of and operation of various graphical user interfaces (GUIs). Commands are typically issued within such GUIs by using a mouse, trackball, touchpad, or even the user's fingertip on a touch-sensitive screen, to move a pointer until it overlays an icon, menu item, window or other object. Once the pointer is positioned, the object can be selected through a user gesture, such as a mouse click or a finger tap. Various operations can then be performed with the selected object through similar user gestures.

As an example, objects or programs can be opened by clicking on their associated icons within the GUI. As another example, icons and windows can be moved, or dragged, within a GUI by first selecting an object with a pointer, depressing and holding a mouse button, and then moving the mouse to reposition the selected object. Once the object is in the desired location within the GUI, the user releases the mouse button and the object remains in its new location.

In general, GUIs make computer operation more intuitive, and by extension, easier to learn and use. However, this is not always the case. For example, drag-and-drop operations involve selecting an object within a GUI, dragging it until it is positioned over another object, and then “dropping” it by releasing the mouse button. As a result, a corresponding action is invoked, such as creating an association between the two objects. However, it is not always clear to users that a given object can be dragged and dropped. Furthermore, it may be equally unclear which objects within the GUI are viable targets, even though their appearance may change when they are selected by a user gesture. Moreover, it is often difficult for a user to determine the presumed outcome of an associated drag-and-drop operation in advance, especially if the target object is hidden under other objects. As a result, the usability of drag-and-drop operations is negatively affected.

### SUMMARY OF THE INVENTION

A system, method, and computer-readable medium are disclosed for assisting a user in performing a drag-and-drop operation within a graphical user interface (GUI). In various embodiments, drag-and-drop assistance operations are initiated by the selection of a source graphical object within a GUI. Association data corresponding to the selected source graphical object is processed to identify associated target graphical objects. Once the associated target graphical objects have been identified, visual indication data is processed to generate a visual cue, which is then displayed within the GUI and used to assist the user in performing a drag-and-drop operation.

In various embodiments, the visual cue comprises applying a visual attribute to the second graphical object when the first graphical object is selected. In these and other embodiments, the visual attribute may comprise a color, a graphical shape, a graphical manipulation of the second graphical object, or a text box comprising text. In one embodiment, the visual cue comprises a graphical shape, such as an arrow, that indicates the direction the first graphical object is to be dragged within the GUI. In another embodiment, a visual attribute (e.g., a ghost image) is applied to various other graphical objects within the GUI when a source graphical object is selected to indicate they are not associated with the source graphical object.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the system and method of the present invention;

FIGS. 2a-e show the display of visual cues within a graphical user interface (GUI) to assist a user in performing a drag-and-drop operation;

FIG. 3 shows the selective display of a plurality of visual cues within a GUI to assist a user in performing a drag-and-drop operation; and

FIG. 4 is a generalized flow chart of the performance of drag-and-drop assistance operations within a GUI.

### DETAILED DESCRIPTION

A system, method, and computer-readable medium are disclosed for assisting a user in performing a drag-and-drop operation within a graphical user interface (GUI). For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

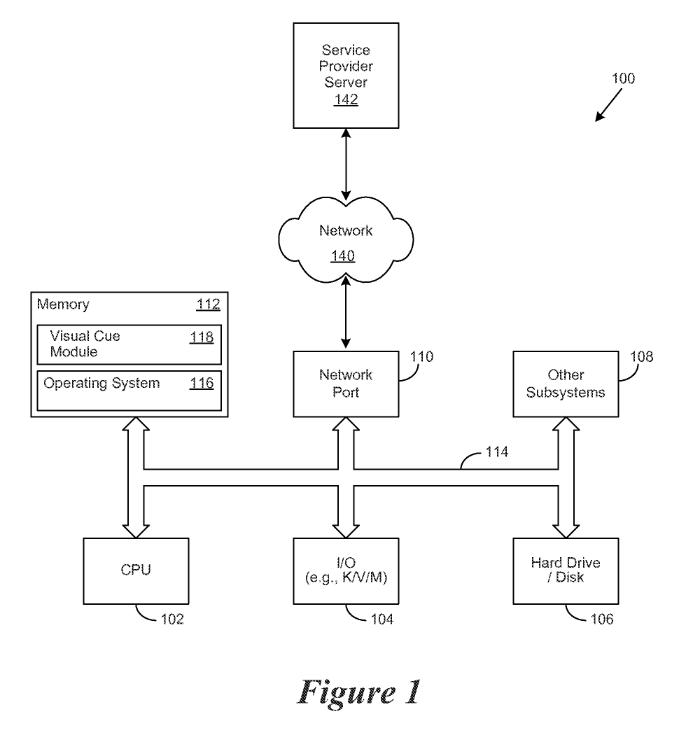

FIG. 1 is a generalized illustration of an information handling system 100 that can be used to implement the system and method of the present invention. The information handling system 100 includes a processor central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a drag-and-drop assistance module 118. In one embodiment, the information handling system 100 is able to download the drag-and-drop assistance module 118 from the service provider server 142. In another embodiment, the drag-and-drop assistance module 118 is provided as a service from the service provider server 142.

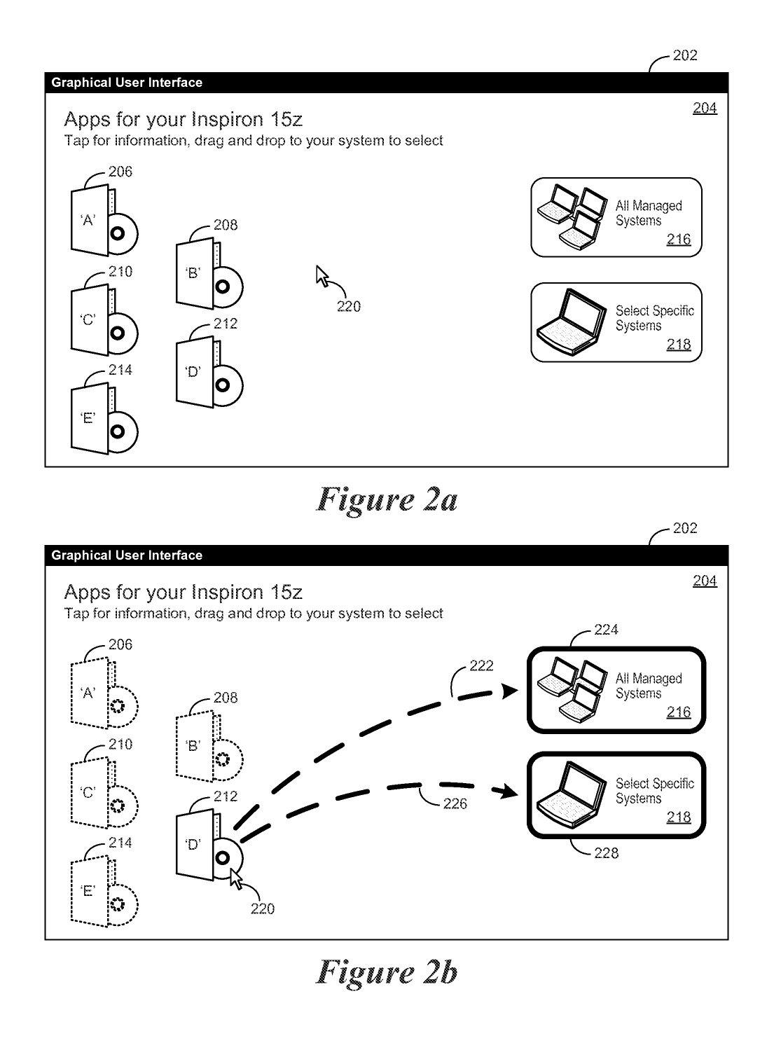

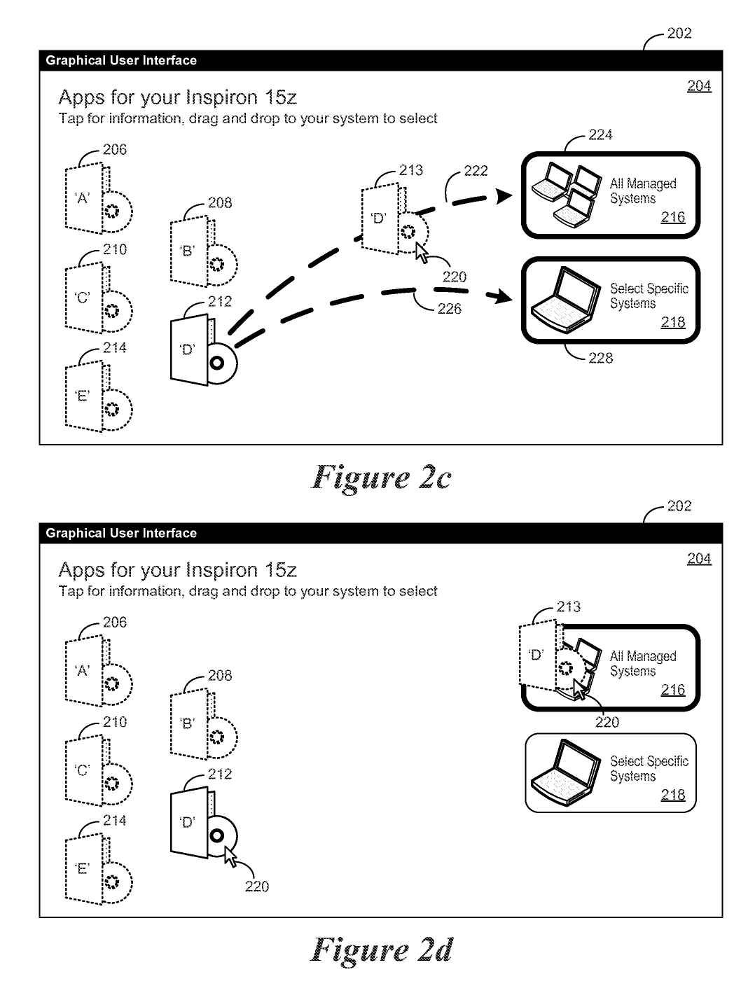

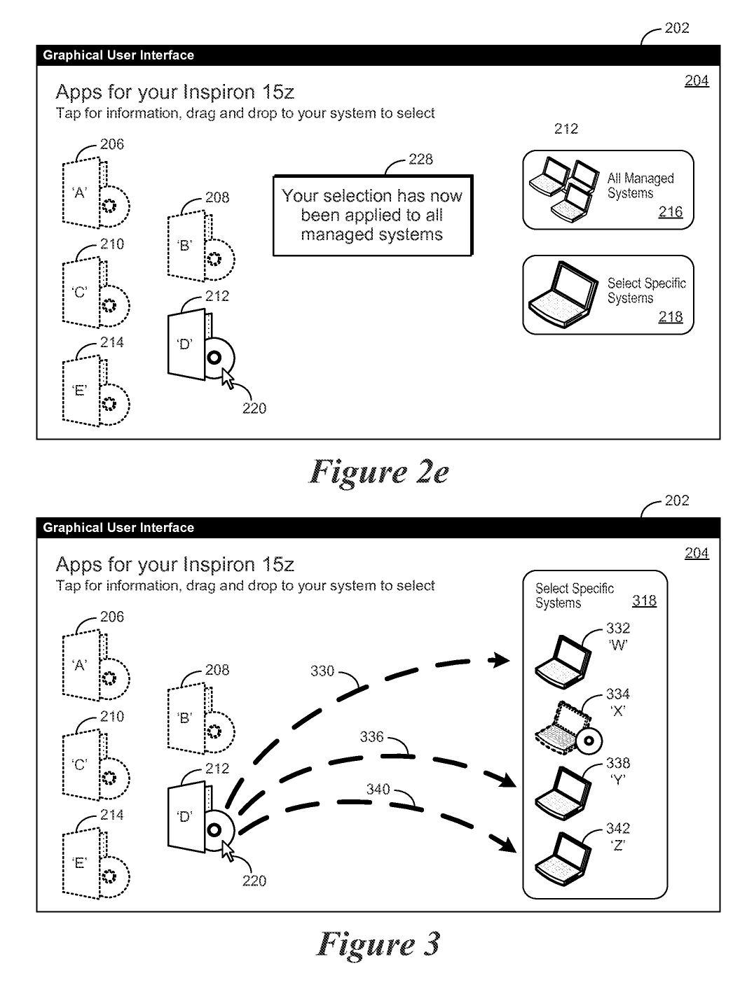

FIGS. 2a-e show the display of visual cues within a graphical user interface (GUI) to assist a user in performing a drag-and-drop operation in accordance with an embodiment of the invention. In various embodiments, a drag-and-drop assistance module is implemented to assist a user in performing drag-and drop operations in a GUI. In this embodiment, as shown in FIG. 2a, a GUI 202 comprises a user interface (UI) window 204, which further comprises a plurality of source graphical objects labeled ‘A’ 206, ‘B’ 208, ‘C’ 210, ‘D’ 212, ‘E’ 214, which represent corresponding software applications. The UI window 204 likewise comprises a pointer 220 and a plurality of target graphical objects labeled “All Managed Systems” 216 and “Select Specific Systems” 218, which represent corresponding groups of systems.

Referring now to FIG. 2b, the pointer 220 is placed over graphical object ‘D’ 212, which is selected through a user gesture, such as a mouse click or a user's fingertip performing a tap operation on a touch-sensitive screen. As a result, association data corresponding to the of source graphical objects labeled ‘A’ 206, ‘B’ 208, ‘C’ 210, ‘D’ 212, ° E′ 214 and to the target graphical objects labeled “An Managed Systems” 216 and “Select Specific Systems” 218 is processed to determine potential graphical object associations.

Once they are determined, associated visual indication data is processed to generate visual cues corresponding to the potential graphical object associations. In one embodiment, these visual cues may comprise a graphical shape, such as arrows 222 and 226, to indicate the direction the source graphical object ‘D’ 212 is to be dragged, as well as the intended destinations, where it can be dropped, which include the target graphical objects labeled “All Managed Systems” 216 and “Select Specific Systems” 218. The direction of drag away from the source and approach distance to potential targets may be utilized to further select the most applicable choices.

In various embodiments, a visual attribute 224, 228 may be applied to the target graphical object (e.g., box, circle, oval, etc.), a color, or a graphical manipulation, such as making the target graphical object appear larger within the UI 204. In these and other embodiments, a visual attribute may be applied to source graphical objects (e.g., source graphical objects ‘A’ 206, ‘B’ 208, ‘C’ 210, and ‘E’ 214) that are not selected by the user. It will be appreciated that the application of such visual attributes, when implemented in combination with the aforementioned visual cues, would assist a user in performing a drag-and-drop operation within the UI window 204. Those of skill in the art will likewise recognize that many such visual attributes are possible and the foregoing is not intended to limit the spirit, scope or intent of the invention.

Referring now to FIG. 2c, the pointer 220, in combination with a user gesture such as a mouse click, is used to drag the source graphical object ‘D’ 212, or a copy 213, along the arrow shape of the visual clue 222 to the target graphical object labeled “All Managed Systems” 216. Then, as shown in FIG. 2D, the source graphical object “D” 212, or its copy 213, is then placed over the target graphical object labeled “All Managed Systems” 216, which results in the removal of visual cues, such as copy 213, arrows 222, 226, as well as the visual attribute 224 applied to the target graphical objects labeled “Select Specific Systems” 218.

The source graphical object ‘D’ 212, or copy 213, is then dropped onto the target graphical object labeled “All Managed Systems” 216. As a result, association operations are initiated between the software application and systems respectively corresponding to the source graphical object ‘D’ 212 and the target graphical object labeled “All Managed Systems” 216. Thereafter, as shown in FIG. 2e, text box 228 is displayed within the UI window 204 to notify the user that, the association operation has been completed. In one embodiment, the association operation comprises the purchase of the software application corresponding to the source graphical object ‘D’ 212 and its subsequent assignment to the systems corresponding to the target graphical object labeled “All Managed Systems” 216. In another embodiment, the association operation comprises the assignment of licenses associated with the software application corresponding to the source graphical object ‘D’ 212 to the systems corresponding to the target graphical object labeled “All Managed Systems” 216. Skilled practitioners of the art will recognize that many such embodiments are possible and the foregoing is not intended to limit the spirit, scope or intent of the invention.

FIG. 3 shows the selective display of a plurality of visual cues within a graphical user interface (GUI) to assist a user in performing a drag-and-drop operation in accordance with an embodiment of the invention. In this embodiment, as shown in FIG. 3, a GUI 202 comprises a user interface (UI) window 204, which further comprises a plurality of source graphical objects labeled ‘A’ 206, ‘B’ 208, ‘C’ 210, ‘D’ 212, ‘E’ 214, which represent corresponding software applications. The UI window 204 likewise comprises a pointer 220 and a plurality of target graphical objects labeled ‘W’ 332, ‘X’ 334, ‘Y’ 340, ‘Z’ 344, which correspond to various individual systems.

As described in greater detail herein, the pointer is placed over graphical object ‘D’ 212. As a result, association data corresponding to the of source graphical objects labeled ‘A’ 206, ‘B’ 208, ‘C’ 210, ‘D’ 212, ‘E’ 214 and to the target graphical objects labeled ‘W’ 332, ‘X’ 334, ‘Y’ 340. ‘Z’ 344 to determine potential graphical object associations.

Once they are determined, associated visual indication data is processed to generate visual cues corresponding to the potential graphical object associations. In one embodiment, these visual cues may comprise a graphical shape, such as arrows 330, 338, and 342, to indicate the direction the source graphical object ‘D’ 212 is to be dragged, as well as the intended destinations, where it can potentially be dropped, which include the target graphical objects labeled ‘W’ 332, ‘Y’ 340, ‘Z’ 344. The direction of drag away from the source and approach distance to potential targets may be utilized to further select the most applicable choices.

In various embodiments, a visual attribute may be applied to source graphical objects (e.g., source graphical objects ‘A’ 206, ‘B’ 208, ‘C’ 210, and ‘E’ 214) that are not selected by the user. Likewise, a visual attribute, such as a ghosting effect, may be applied to the target graphical object, such as the target graphical object ‘X’ 334, to indicate that it does not have a potential association with the source graphical object ‘D’ 212. As an example, the system corresponding to the target graphical object ‘X’ 334 may already have a valid assignment of the software application corresponding to the source graphical object ‘D’ 212. As a result, a visual attribute is applied to ghost its image. In various embodiments, additional graphical objects, such as the disk icon 336, may be combined with the target graphical object to further indicate the lack of a potential association with a source graphical object. Drag-and-drop operations are then performed as described in greater detail herein.

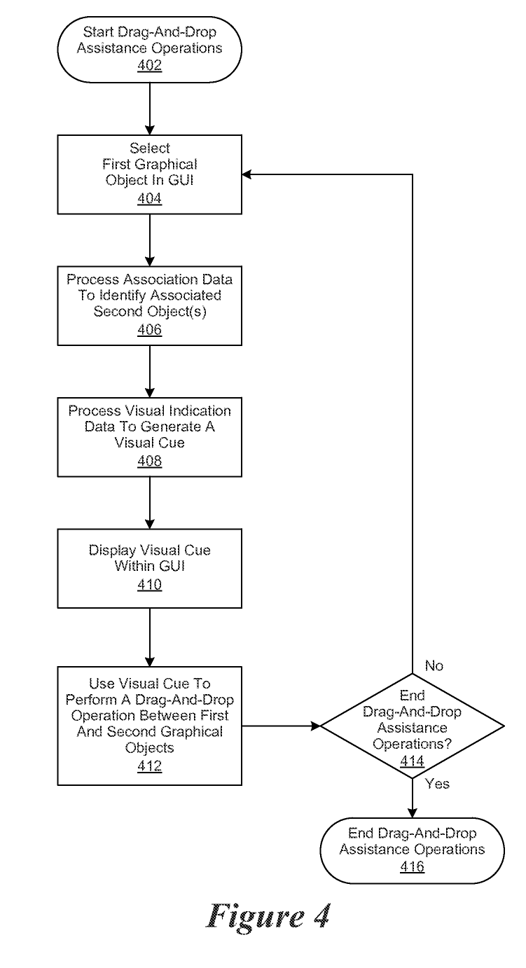

FIG. 4 is a generalized flow chart of the performance of drag-and-drop assistance operations within a graphical user interface (GUI) in accordance with an embodiment of the invention. In this embodiment, drag-and-drop assistance operations are begun in step 402, followed by the selection of a source graphical object within a GUI in step 404. Then, in step 406, association data corresponding to the selected source graphical object is processed to identify associated target graphical objects. Once the associated target graphical objects have been identified, visual indication data is processed in step 408 to generate a visual cue, which is then displayed within the GUI in step 410.

In various embodiments, the visual indication data comprises drag direction and distance data. In these and other embodiments, the drag direction data corresponds to the direction the source graphical object is dragged within the GUI and the distance data corresponds to the distance between the source and target graphical objects. In these various embodiments, the visual indication data is further processed to determine which visual cue is displayed within the GUI. As an example, a GUI may be crowded with multiple source and target graphical objects. Depending upon the distance between a selected source graphical and its associated target graphical objects, and the direction of the drag operation, different visual cues may be displayed to assist the user in performing a drag-and-drop operation. The visual cue is then used in step 412 to assist the user in performing a drag-and-drop operation within the GUI. A determination is then made in step 414 whether to end drag-and-drop assistance operations. If not, then the process is continued, proceeding with step 404. Otherwise, drag-and-drop assistance operations are ended in step 416.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

For example, the above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A computer-implementable method for assisting a drag-and-drop operation within a graphical user interface (GUI), comprising:
receiving user input data to select a first graphical object within a GUI;
processing association data to identify a second graphical object within the GUI, the second graphical object associated with the first graphical object;
processing visual indication data to generate a visual cue, the visual indication data corresponding to the association; and
displaying the visual cue within the GUI, the visual cue providing a visual indication of the association.

2. The method of claim 1, wherein:
the visual indication data is further processed to determine the visual cue to be displayed;
the visual indication data comprises drag direction data and distance data, the drag direction data comprising the direction of a drag operation and the distance data corresponding to the distance between the first and second graphical objects; and
the display of the visual cue comprises the application of a visual attribute to the second graphical object when the first graphical object is selected.

3. The method of claim 2, wherein the visual attribute comprises at least one of the set of:
a color;
a graphical shape;
a graphical manipulation of the second graphical object, and
a text box comprising text.

4. The method of claim 1, wherein the visual cue comprises a graphical shape indicating the direction the first graphical object is to be dragged within the GUI.

5. The method of claim 1, wherein a visual attribute is applied to a third graphical object within the GUI when the first graphical object is selected, the visual attribute comprising a ghost image of the third graphical object, the third graphical object not associated with the first graphical object.

6. The method of claim 1, wherein the user input data comprises a user gesture associated with the GUI.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
receiving user input data to select a first graphical object within a GUI;
processing association data to identify a second graphical object within the GUI, the second graphical object associated with the first graphical object;
processing visual indication data to generate a visual cue, the visual indication data corresponding to the association; and
displaying the visual cue within the GUI, the visual cue providing a visual indication of the association.

8. The system of claim 7, wherein:
the visual indication data is further processed to determine the visual cue to be displayed;
the visual indication data comprises drag direction data and distance data, the drag direction data comprising the direction of a drag operation and the distance data corresponding to the distance between the first and second graphical objects; and
the display of the visual cue comprises the application of a visual attribute to the second graphical object when the first graphical object is selected.

9. The system of claim 7, wherein the visual attribute comprises at least one of the set of:
a color;
a graphical shape;
a graphical manipulation of the second graphical object, and
a text box comprising text.

10. The system of claim 7, wherein the visual cue comprises a graphical shape indicating the direction the first graphical object is to be dragged within the GUI.

11. The system of claim 7, wherein a visual attribute is applied to a third graphical object within the GUI when the first graphical object is selected, the visual attribute comprising a ghost image of the third graphical object, the third graphical object not associated with the first graphical object.

12. The system of claim 7, wherein the user input data comprises a user gesture associated with the GUI.

13. A non-transitory, computer-readable storage medium embodying computer program code, the computer program code comprising computer executable instructions configured for:
receiving user input data to select a first graphical object within a GUI;
processing association data to identify a second graphical object within the GUI, the second graphical object associated with the first graphical object;
processing visual indication data to generate a visual cue, the visual indication data corresponding to the association; and
displaying the visual cue within the GUI, the visual cue providing a visual indication of the association.

14. The non-transitory, computer-readable storage medium of claim 13, wherein:
the visual indication data is further processed to determine the visual cue to be displayed;
the visual indication data comprises drag direction data and distance data, the drag direction data comprising the direction of a drag operation and the distance data corresponding to the distance between the first and second graphical objects; and
the display of the visual cue comprises the application of a visual attribute to the second graphical object when the first graphical object is selected.

15. The non-transitory, computer-readable storage medium of claim 13, wherein the visual attribute comprises at least one of the set of:
a color;
a graphical shape;
a graphical manipulation of the second graphical object, and
a text box comprising text.

16. The non-transitory, computer-readable storage medium of claim 13, wherein the visual cue comprises a graphical shape indicating the direction the first graphical object is to be dragged within the GUI.

17. The non-transitory, computer-readable storage medium of claim 13, wherein a visual attribute is applied to a third graphical object within the GUI when the first graphical object is selected, the visual attribute comprising a ghost image of the third graphical object, the third graphical object not associated with the first graphical object.

18. The non-transitory, computer-readable storage medium of claim 13, wherein the user input data comprises a user gesture associated with the GUI.
